(19) United States
(12) Patent Application Publication
(10) Pub. No.: US 2005/0208226 A1
(43) Pub. Date: Sep. 22, 2005

(54) Coating device

(75) Inventors: Wilfried Platzer, Krefeld (DE); Ernst-Werner Schmidt, Langenfeld (DE); Alireza Kouscheschi, Koln (DE); P. Klaus Becker, Hunxe (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: BAND-ZINK GmbH, Langenfeld (DE)

(21) Appl. No.: 10/514,029

(22) PCT Filed: May 8, 2003
(86) PCT No.: PCT/EP03/04822

§ 371 Date: Nov. 9, 2004

(30) Foreign Application Priority Data
May 11, 2002 (DE) 202 07 446.3

(51) Int. Cl. B05C 3/00; B05D 1/18

(52) U.S. Cl. 427/435; 118/623; 118/400

(57) ABSTRACT

A coating device (10) coats a metal strip (12) in a melting (14) of a coating metal. For guiding and deviating the metal strip (12), a guiding device (16) is arranged in the melting (14). The guiding device (16) is configured as a magnetic guide with at least one electric guide magnet for the contactless guidance of the metal strip in the melting (14). Thereby, the use of rolls, shafts etc. for guiding the metal strip is avoided so that the coating of the metal strip (12) with the coating metal is of a better quality and has the same quality on both sides of the metal strip (12).

The invention relates to a coating device for coating a metal strip in a melting of a coating metal.

Coating devices for the coating of metal strips are used, e.g., for galvanizing metal strips and sheet metals. In doing so, the metal strip is pulled through a zinc melting that is about 450° C. hot: The metal strip is continuously immersed downward into the zinc melting, is deviated upwards by a rotating shaft in the melting and runs upward out of the zinc melting again. When passing the zinc melting, the metal strip is supported over a certain length all over on the rotating shaft with one side thereof and at a certain contact pressure. Thereby, the zinc coating that has already settled down on the respective side of the metal strip is partially squeezed off again. Stabilizing rolls and other rolls over which the coated metal strip runs undesirably alter the zinc coating still liquid as well.

It is an object of the invention to provide a coating device with an improved coating of a metal strip in a melting of a coating metal.

This object is solved, according to the invention, with the features of claim 1.

According to the coating device according to the invention, a metal strip guiding device for guiding, deviating and/or stabilizing the metal strip is pro-vided in the melting, which is configured as a magnetic guide with at least one electric guide magnet for the contactless guidance of the metal strip in the melting. In the melting of the non-magnetic coating metal, the metal strip is guided in a contactless manner, i.e., without rolls, shafts etc., but only by the magnetic field produced by the guide magnet, which acts about vertically to the metal strip plane. Through the contactless guidance of the metal strip in the melting, the coating of the metal strip with the liquid coating metal is no longer affected by rolls, shafts, etc. so that an approximately similar coating of the metal strip with the coating metal is realized on both sides of the metal strip. Thereby, the quality of the coating on the metal strip is considerably improved. The electric guide magnet in the melting of the coating metal is arranged and controlled such that the metal strip is deviated in the melting. By avoiding a shaft in the melting, the problems of bearing the shaft in a molten metal are avoided.

Preferably, a guide magnet housing is provided in which the guide magnet is arranged and which consists of a non-magnetic material the melting point of which lies above 600° C. By the guide magnet housing, the guide magnet is encapsulated in the melting of the coating metal and protected from the high temperatures and the chemically aggressive molten coating metal. The guide magnet housing, for example, may be configured as a stainless steel housing.

According to a preferred embodiment, two opposite guide magnet housings with electric guide magnets are provided, the guide magnet housings forming a continuous metal strip guiding gap between the two of them. This means that guide magnets are arranged at both sides of the metal strip so that the metal band can be attracted by the respective guide magnets in both directions vertically to the metal strip base plane.

In the guiding gap, electromagnetic fields are generated by the guide magnets by which fields the coating metal is heated within the guiding gap. Thereby, a coating of the metal strip with the coating metal is made possible which is of particular high quality. In the guiding gap, liquid melting of the coating metal is also located between the opposite guide magnet housings at both sides of the metal strip running through the guiding gap.

Preferably, the guiding gap between the two guide magnet housings has an arcuate configuration so that the metal strip is deviated in the guiding gap. Thus, the metal strip is deviated over an arcuate course in the molten coating metal without having a large clearance in this region. Thereby, a strong fluttering movement of the metal strip in the molten metal is avoided.

According to a preferred embodiment, the guiding device comprises a sensor for detecting the distance of the metal strip to the guide magnet. Further, a control device is provided, controlling the strength of the magnetic field produced by the guide magnet in dependence on the distance of the metal strip from the guide magnet, which has been detected by the sensor. Thus, the distance of the metal strip from the guiding device or the guide magnet is held approximately constant. Variations of the nominal distance of the metal strip from the guiding device or the guide magnet are immediately detected by the sensor and leveled out by a corresponding control of the electric guide magnet.

Preferably, a gas supply is provided by means of which the guide magnet housing is supplied with cooling gas for cooling the guide magnet. The guide magnet configured as an electromagnet has a better efficiency at lower working temperatures than at higher temperatures, i.e., the magnetic field produced is stronger at lower working temperatures. The efficiency of the guide magnet is improved by cooling so that a smaller guide magnet can be used. Further, the cooling gas can produce a slight overpressure with respect to the static pressure of the molten coating metal in the guide magnet housing so that in case of a leakage of the guide magnet housing, cooling gas escapes but liquid coating metal cannot enter the guide magnet housing. Thus, heavy damage to the guiding device is avoided.

Further, a gas pressure sensor for detecting gas leakage currents can be provided in the guide magnet housing. This may be, e.g., a pressure sensor that detects the gas pressure within the guide magnet housing. A pressure drop in the housing would hint at a leakage of the guide magnet housing so that damage to the guide magnet housing can be recognized early and greater damage can be avoided.

In the region of the metal strip guiding gap, the guide magnet housing can preferably be provided with an emergency running coating that may be configured as a ceramic coating, for example. Even if the electromagnetic guiding device fails, a controlled setting back of the installation is possible and an immediate destruction of the guiding device is avoided.

The guiding device may be configured as a deviating device, as a stabilizing device or rather as a combined deviating and stabilizing device.

According to a preferred embodiment, a cleaning device for cleaning the guiding gap is provided. The cleaning device may comprise a scraper mounted to a scraper pull and being able to be pulled through the guiding gap by means of the scraper pull. In the region of the guiding gap, the guide magnet housing is cleaned by the cleaning device, i.e., formations of slag and other precipitations at the housing are scraped off and guided out of the guiding gap. The guiding pull may have a cable- or strip-like configuration and consists of a non-magnetic material.

Hereinafter, an embodiment of the invention is explained in detail with reference to the drawings.

In the Figures:

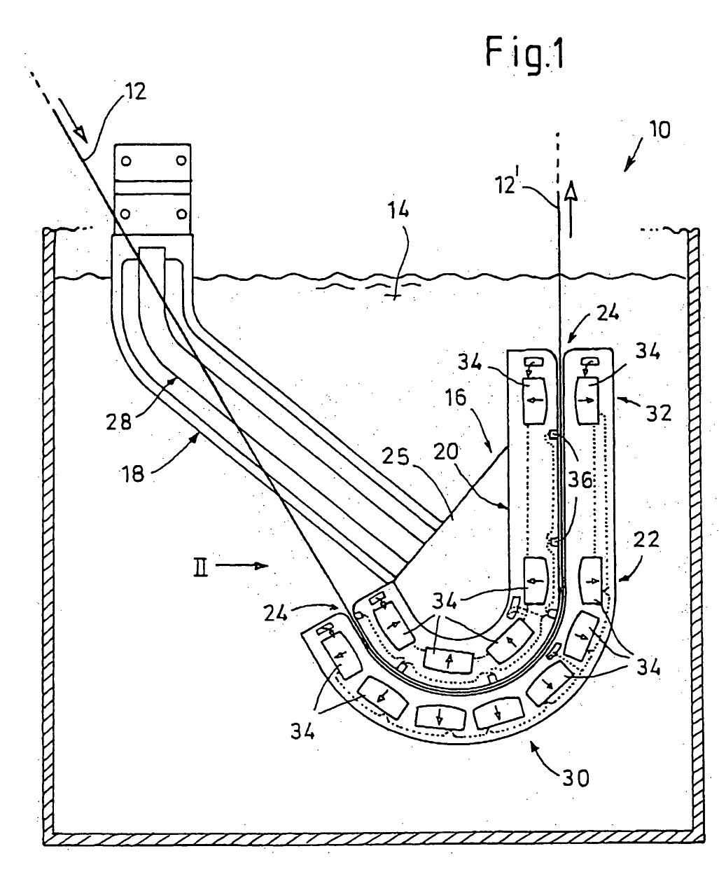

FIG. 1 shows a coating device according to the invention, with a guiding device in a zinc melting in cross-section,

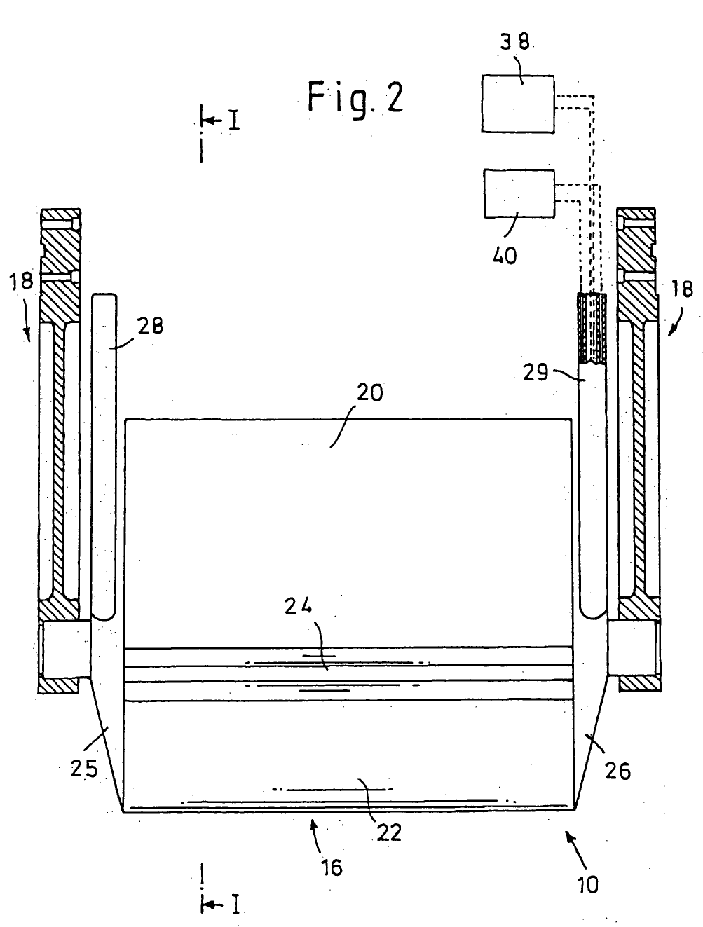

FIG. 2 shows the coating device of FIG. 1 in rear view, and

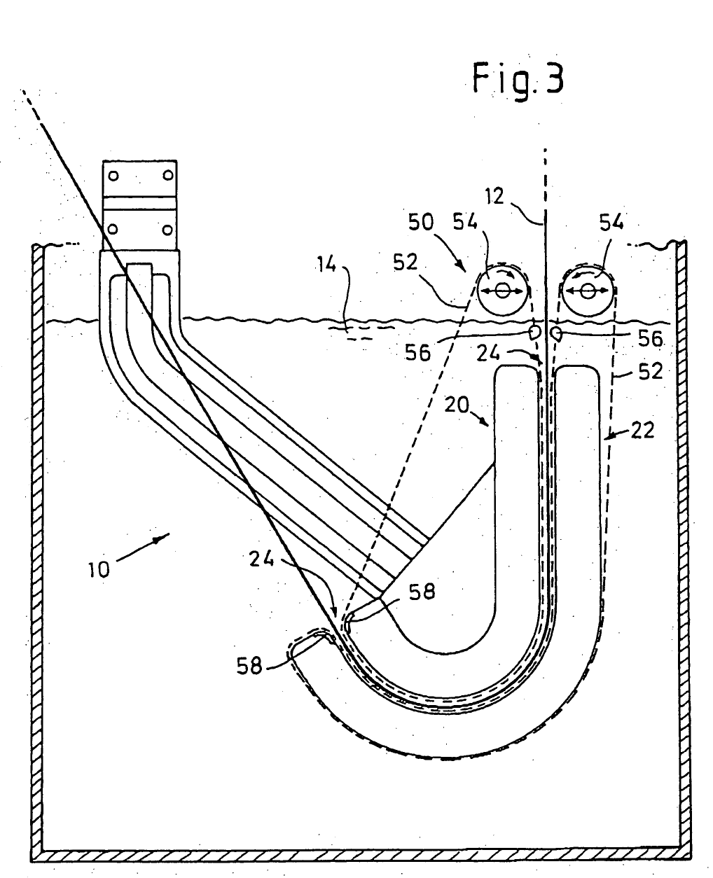

FIG. 3 shows the coating device of FIG. 1 with a cleaning device.

In FIG. 1, a coating device 10 is illustrated in cross-section, serving for coating a metal strip 12 with the coating metal of the melting 14. The coating metal is zinc, but may also be another metal suitable for the described coating device 10 with respect to its magnetic characteristics. Suitable are all coating metals which, because of their magnetic characteristics, do not have such a strong influence upon the magnetic fields produced by guide magnets 34 that their effect on the metal strip 12 is reduced such thereby that the effort required to guide the metal strip 12 is unjustifiable. Hereinafter, they are referred to as non-magnetic coating metals.

In the coating device 10, the surfaces of both sides of the metal strip 12 are provided with a thin zinc layer. The zinc melting 14 has a temperature of 450-470° C. The metal strip 12 is introduced into the melting 14 at an angle of 30-45 degree to the vertical line and deviated upwards by a guiding device 16 so that the metal strip 12′ is guided vertically upward out of the melting 14 again.

The guiding device 16 is held by two pivot arms 18, as illustrated in FIG. 2. The pivot arms 18 are pivotably supported above the melting 14 so that the guiding device 16 can be pivoted out of the melting 14 for maintenance or repair when required. If necessary, the arms 18 are also lifted out of the melting 14 together with the guiding device 16 by means of a crane.

The guiding device 16 is formed by two guide magnet housings 20, 22 forming a continuous metal strip guiding gap 24 between the two of them. The two guide magnet housings 20, 22 are laterally held together by screwed-down or welded-on retaining parts 25, 26, respectively. Each of the retaining parts 25, 26 comprises a stud inserted into a respective retaining opening of the pivot arms 18.

At each retaining part 25, 26, a supply tube 28, 29 is fastened. Through the supply tubes 28, 29, the housings 20, 22 are supplied with a cooling gas and the heated cooling gas is carried off from the housings 20, 22, respectively. Further, the supply tubes 28, 29 include electrical signal and control lines.

In terms of function, the guiding device 16 is divided into a deviating portion 30 and a stabilizing portion 32. In the region of the deviating portion 30, the guiding gap 24 has an arcuate configuration. In the region of the following stabilizing portion 32, the guiding gap 24 has a linearly vertical configuration. While the metal strip 12 is deviated by 135-150 degree in the region of the deviating portion 30, the metal strip 12 is stabilized and steadied in the region of the stabilizing portion 32 with respect to its horizontal fluttering movements.

Both guide magnet housings 20, 22 include a plurality of electric guide magnets 34 by means of which the metal strip 12 is always held about in the middle of the guiding gap 24. The illustrated arrows in the guide magnets represent the direction of the magnetic force acting on the metal strip. The retaining parts 25, 26 form magnetic flux guides for the guide magnets. Further, several sensors 36 are provided in the inner guide magnet housing 20, serving the detection of the distance of the metal strip 12 from the respective guide magnets 34 and the central position in the guiding gap 24, respectively. In dependence on the distance signals of the sensors 36, the electromagnetic guide magnets 34 are controlled by a control device 38 in such a manner that the metal strip 12 is always positioned approximately in the middle of the guiding gap 24. The guide magnets 34 produce an alternating field so that a segregation of the mixture of the melting 14, which might possibly include several components, is excluded.

A gas supply 40 supplies the guide magnet housings 20, 22 with the cooling gas. Preferably, nitrogen is used as cooling gas.

In the region of the guiding gap 24, the two housings 20, 22 comprise a ceramic emergency running coating to ensure an emergency running characteristic of the guiding device 16 if the guide magnets 34 fail. If the guide magnets 34 fail, a destruction of the guiding device 16 will be avoided thereby.

By the electromagnetic fields produced by the guide magnets, the melting is heated more or less in the region of the guiding gap 24 in dependence on the magnetic characteristics of the melting metal. Thereby, it is ensured that the melting 14 remains liquid in the region of the guiding gap 24 whereby, in turn, a good coating quality is guaranteed.

The contactless guidance and control of the metal strip 12 in the melting 14 of the coating metal realizes a qualitatively equivalent coating on both sides of the metal strip 12.

In FIG. 3, the coating device 10 of FIGS. 1 and 2 is supplemented by a cleaning device 50. Substantially, the cleaning device 50 is formed by two self-contained endless scraper pulls 52 passed through the guiding gap 24 at both sides of the metal strip 12 and returning outside of the guiding gap 24. Each of the two scraper pulls 52 is driven by a driving roll 54 arranged above the melting. At each scraper pull 52, a respective scraper element 56 is arranged which is fixed firmly at the scraper pull 52. Each of the two guiding gap openings is provided with ceramic inserts 58 by which the scraper pulls 52 are deviated without any considerable wear occurring at the guide magnet housings 20, 22.

In order to clean the guiding gap 24, the two driving rolls 54 are put into motion in opposed senses by a corresponding drive. Thereby, the two scraper pulls 52 move through the guiding gap 24 from above to below while taking along the two scraper elements 56. In the guiding gap 24, the scraper elements 56 scrape off slag and other precipitations from the two opposite housing walls and carry them out of the guiding gap 24. Thus, a simple and efficient cleaning device is realized.

1. A coating device for coating a metal strip in a melting of a coating metal, comprising:
a guiding device in the melting for guiding the metal strip, the guiding device being configured as a magnetic guide including:
at least one electric guide magnet for the contactless guidance of the metal strip in the melting.

2. The coating device according to claim 1, wherein the guiding device further includes:
a guide magnet housing in which the guide magnet is arranged and which is constructed of a non-magnetic material the melting point of which lies above 600° C.

3. The coating device according to claim 1, wherein the guiding device further includes:
two opposite guide magnet housings with at least one electric guide magnet disposed in each housing, the two guide magnet housings forming a continuous metal strip guiding gap between the two of them.

4. The coating device according to claim 3, wherein the guiding gap has an arcuate configuration so that the metal strip is deviated arcuately in the guiding gap.

5. The coating device according to claim 2, wherein the guiding device further includes:
a sensor for detecting the distance of the metal strip from the guide magnet, and
a control device which controls the strength of the magnetic field produced by the guide magnet in dependence on the distance of the metal strip from the guide magnet, which has been detected by the sensor.

6. The coating device according to claim 2, wherein the guiding device further includes:
a gas supply by means of which the guide magnet housing is supplied with cooling gas for cooling the guide magnet.

7. The coating device according to claim 6, wherein the guiding device further includes:
a gas pressure sensor for detecting gas leakage currents in the guide magnet housing.

8. The coating device according to claim 2, wherein the guide magnet housings comprises:
an emergency running coating in the region of the metal strip guiding gap.

9. The coating device according to claim 3, further including:
a cleaning device for cleaning the guiding gap.

10. The coating device according to claim 9, wherein the cleaning device comprises:
a scraper element mounted to a scraper pull, which is adapted to be pulled through the guiding gap by means of the scraper pull.

11. A coating device for coating a metal strip with a coating metal, the coating device comprising:
a pair of non-magnetic guide housings which define a gap therebetween, the guide housings being disposed within a reservoir of liquid coating metal and the metal strip passing through the gap;
magnets mounted in the housing for applying forces to the metal strip in the gap;
a magnet control for controlling electric current to the magnets such that the magnets provide opposing forces which bias the metal strip to be substantially centered in the gap.

12. The coating device according to claim 11 further including:
sensors for sensing a position of the metal strip within the gap, the magnet control being connected with the sensor for adjusting electric current applied to the magnets in accordance with the sensed metal strip position in the gap.

13. The coating device according to claim 11, wherein the magnet control applies alternating current to the electromagnets such that the magnets both control the position of the metal strip within the gap and supply heat to the metal within the gap.

14. The coating device according to claim 11, further including:
a gas supply which supplies cooling gas to the guide housings.

15. The coating device according to claim 14 further including a gas pressure sensor for detecting gas leakage in the guide housing.

16. The coating device according to claim 11, further including:
a ceramic coating on surfaces of the guide housings facing the gap to protect the housings from inadvertent contact with the metal strip.

17. The coating device according to claim 11, further including:
a scraper device mounted to be moved through the gap.

18. A method of coating a metal strip comprising:
passing a metal strip down into a bath of coating metal;
electromagnetically and contactlessly turning the metal strip upward and directing the metal strip out of the coating metal.

19. The method according to claim 18, wherein the electromagnetic guiding step includes:
applying an AC electromagnetic field which both guides the metal strip and heats the coating metal adjacent the metal strip.
